(19) United States
(12) Patent Application Publication
(10) Pub. No.: US 2025/0193714 A1
(43) Pub. Date: Jun. 12, 2025

(54) METHOD AND APPARATUS FOR WIRELESS COMMUNICATION

(71) Applicant: QUECTEL WIRELESS SOLUTIONS CO., LTD., Shanghai (CN)

(72) Inventors: Ling LYU, Shanghai (CN); Zheng ZHAO, Shanghai (CN); Zhongzhi YANG, Shanghai (CN)

(21) Appl. No.: 19/053,778

(22) Filed: Feb. 14, 2025

Related U.S. Application Data
(63) Continuation of application No. PCT/CN2023/086597, filed on Apr. 6, 2023.

(51) Int. Cl. H04W 24/08; H04W 28/04

(52) U.S. Cl. CPC H04W 24/08; H04W 28/04

(57) ABSTRACT

The present disclosure provides a method and apparatus for wireless communication. One example method includes receiving, by a first communication device, first information. The first information is used to determine a PDU set error rate corresponding to one or more PDU sets that a second communication device needs to transmit to the first communication device. The first information includes at least one of: second information corresponding to the one or more PDU sets, a number of the one or more PDU sets, or a number of unsuccessfully transmitted PDU sets in the one or more PDU sets.

### CROSS-REFERENCE TO RELATED APPLICATIONS

This application is a continuation of International Application No. PCT/CN2023/086597, filed on Apr. 6, 2023, the disclosure of which is hereby incorporated by reference in its entirety.

### TECHNICAL FIELD

The present disclosure relates to the field of communication technology, and more specifically to a method and apparatus for wireless communication.

### BACKGROUND

With the development of communication technologies, new services with high data transmission volumes, such as extended reality (XR) services, are becoming increasingly feasible. The data for these services is typically organized and transmitted as a protocol data unit (PDU) set.

In a communication link, a receiver communication device may not receive a complete set of PDUs that a sender communication device intended to send. How the receiver determines a PDU set error rate based on the received data is an urgent problem to be solved.

### SUMMARY

The present disclosure provides a method and apparatus for wireless communication, which help the receiver communication device to determine the PDU set error rate.

According to a first aspect, a method for wireless communication is provided, including: receiving, by a first communication device, first information, where the first information is used to determine a PDU set error rate corresponding to one or more PDU sets that a second communication device needs to transmit to the first communication device; where the first information includes one or more of: second information corresponding to the one or more PDU sets, where the second information is used for the first communication device to determine whether a received PDU set is successfully transmitted, a number of the one or more PDU sets, and a number of unsuccessfully transmitted PDU sets in the one or more PDU sets.

According to a second aspect, a method for wireless communication is provided, including: sending, by a second communication device, first information to a first communication device, where the first information is used to determine a PDU set error rate corresponding to one or more PDU sets that the second communication device needs to transmit to the first communication device; where the first information includes one or more of: second information corresponding to the one or more PDU sets, where the second information is used for the first communication device to determine whether a received PDU set is successfully transmitted, a number of the one or more PDU sets, and a number of unsuccessfully transmitted PDU sets in the one or more PDU sets.

According to a third aspect, an apparatus for wireless communication is provided, where the apparatus is a first communication device, and the first communication device includes: a receiving unit, configured to receive first information, where the first information is used to determine a PDU set error rate corresponding to one or more PDU sets that a second communication device needs to transmit to the first communication device; where the first information includes one or more of: second information corresponding to the one or more PDU sets, where the second information is used for the first communication device to determine whether a received PDU set is successfully transmitted, a number of the one or more PDU sets, and a number of unsuccessfully transmitted PDU sets in the one or more PDU sets.

According to a fourth aspect, an apparatus for wireless communication is provided, where the apparatus is a second communication device, and the second communication device includes: a sending unit, configured to send first information to a first communication device, where the first information is used to determine a PDU set error rate corresponding to one or more PDU sets that a second communication device needs to transmit to the first communication device; where the first information includes one or more of: second information corresponding to the one or more PDU sets, where the second information is used for the first communication device to determine whether a received PDU set is successfully transmitted, a number of the one or more PDU sets, and a number of unsuccessfully transmitted PDU sets in the one or more PDU sets.

According to a fifth aspect, a communication apparatus is provided, including a memory and a processor, where the memory is configured to store a program, and the processor is configured to invoke the program in the memory to perform the method according to the first aspect or the second aspect.

According to a fourth aspect, a communication apparatus is provided, including a processor, where the processor is configured to invoke a program from a memory to perform the method according to the first aspect or the second aspect.

According to a fifth aspect, a chip is provided, including a processor, where the processor is configured to invoke a program from a memory to cause a device installed with the chip to perform the method according to the first aspect or the second aspect.

According to a sixth aspect, a computer-readable storage medium storing a program is provided, where the program causes a computer to perform the method according to the first aspect or the second aspect.

According to a seventh aspect, a computer program product is provided, including a program, where the program causes a computer to perform the method according to the first aspect or the second aspect.

According to an eighth aspect, a computer program is provided, where the computer program causes a computer to perform the method according to the first aspect or the second aspect.

In the embodiments of the present disclosure, the first communication device determines, based on the first information, an actual transmission status of one or more PDU sets that need to be transmitted by the second communication device. The first information may include second information of the one or more PDU sets that need to be transmitted, the number of PDU sets that need to be transmitted, or the number of unsuccessfully transmitted PDU sets. It can be seen therefrom that the first communication device may calculate the transmission error rate in terms of PDU sets based on the received PDU set and the first information, so as to perform quality of service (QOS) statistics.

### BRIEF DESCRIPTION OF THE DRAWINGS

FIG. 1 is an exemplary diagram of a wireless communication system applied in an embodiment of the present disclosure.

FIG. 2 is a schematic flowchart of performing data transmission based on PDU set importance.

FIG. 3 is a schematic diagram of three situations where the PDU set is not successfully transmitted.

FIG. 4 is a schematic diagram of transmission processes corresponding to the three situations shown in FIG. 3.

FIG. 5 is a schematic diagram of a case where a receiver communication device cannot obtain PSER statistics.

FIG. 6 is another schematic diagram of a case where the receiver communication device cannot obtain PSER statistics.

FIG. 7 is a schematic flowchart of a method for wireless communication according to an embodiment of the present disclosure.

FIG. 8 is a schematic flowchart of a possible implementation of the method shown in FIG. 7.

FIG. 9 is a schematic structural diagram of an apparatus for wireless communication according to an embodiment of the present disclosure.

FIG. 10 is another schematic structural diagram of an apparatus for wireless communication according to an embodiment of the present disclosure.

FIG. 11 is a schematic structural diagram of an apparatus for communication according to an embodiment of the present disclosure.

### DETAILED DESCRIPTION OF THE EMBODIMENTS

The following describes technical solutions in the embodiments of the present disclosure with reference to the accompanying drawings in the embodiments of the present disclosure. Apparently, the described embodiments are part of but not all of the embodiments of the present disclosure. For the embodiments of the present disclosure, all other embodiments obtained by a person of ordinary skill in the art based on the embodiments of the present disclosure without creative efforts shall fall within the protection scope of the present disclosure.

The embodiments of the present disclosure may be applied to various communication systems. For example, the embodiments of the present disclosure may be applied to a global system of mobile communication (GSM) system, a code division multiple access (CDMA) system, a wideband code division multiple access (WCDMA) system, a general packet radio service (GPRS) system, a long term evolution (LTE) system, an advanced long term evolution (LTE-A) system, a new radio (NR) system, an evolution system of the NR system, an LTE-based access to unlicensed spectrum (NTN-U) system, an NR-based access to unlicensed spectrum (NR-U) system, an NTN system, a universal mobile telecommunication system (UMTS), a wireless local area networks (WLAN), a wireless fidelity (WiFi), and a 5^{th}-generation (5G) system. The embodiments of the present disclosure may be further applied to another communication system such as a future communication system. The future communication system may be, for example, a 6th generation (6G) mobile communication system, or a satellite communication system, etc.

Conventional communication systems support a limited number of connections and are easy to implement. However, with the development of communication technologies, the communication system may not only support conventional cellular communication, but also support one or more other types of communication. For example, the communication system may support one or more of device to device (D2D) communication, machine to machine (M2M) communication, machine type communication (MTC), vehicle to vehicle (V2V) communication, vehicle to everything (V2X) communication, and the like. The embodiments of the present disclosure may also be applied to communication systems supporting the above communication types.

The communication system in the embodiments of the present disclosure may be applied to a carrier aggregation (CA) scenario, a dual connectivity (DC) scenario, or a standalone (SA) fabric scenario.

The communication system in the embodiments of the present disclosure may be applied to an unlicensed spectrum. The unlicensed spectrum may also be considered as a shared spectrum. Alternatively, the communication system in the embodiments of the present disclosure may also be applied to a licensed spectrum. The licensed spectrum may also be considered as a dedicated spectrum.

The embodiments of the present disclosure may be applied to a terrestrial network (TN) system or may be applied to the NTN system. As an example, the NTN system may include a 4G-based NTN system, an NR-based NTN system, an internet of things (IoT)-based NTN system, and a narrow band internet of things (NB-IoT)-based NTN system.

The communication system may include one or more terminal devices. The terminal device mentioned in the embodiments of the present disclosure may also be referred to as user equipment (UE), an access terminal, a subscriber unit, a subscriber station, a mobile station (MS), a mobile terminal (MT), a remote station, a remote terminal, a mobile device, a user terminal, a terminal, a wireless communication device, a user agent, a user apparatus, or the like.

In some embodiments, the terminal device may be a STATION (ST) in the WLAN. In some embodiments, the terminal device may be a cellular phone, a cordless phone, a session initiation protocol (SIP) phone, a wireless local loop (WLL) station, a personal digital assistant (PDA) device, a handheld device having a wireless communication function, a computing device or another possessing device connected to a wireless modem, a vehicle-mounted device, a wearable device, a terminal in a next-generation communication system (such as the NR system), or a terminal device in a future evolved public land mobile network (PLMN) network.

In some embodiments, the terminal device may be a device that provides voice and/or data connectivity to a user. For example, the terminal device may be a handheld device or a vehicle-mounted device having a wireless connection function. As some specific examples, the terminal device may be a mobile phone, a pad, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in smart home, etc.

In some embodiments, the terminal device may be deployed on land. For example, the terminal device may be deployed indoors or outdoors. In some embodiments, the terminal device may be deployed on a water surface, for example, deployed on a ship. In some embodiments, the terminal device may be deployed in the air, for example, deployed on an aircraft, a balloon, and a satellite.

In addition to the terminal device, the communication system may further include one or more network devices. The network device in the embodiments of the present disclosure may be a device configured to communicate with the terminal device, and the network device may also be referred to as an access network device or a radio access network device. The network device may be, for example, a base station. The network device in the embodiments of the present disclosure may refer to a radio access network (RAN) node (or device) that accesses the terminal device to a wireless network. The base station may broadly cover various names as follows, or may be replaced with the following names, such as a node B (NodeB), an evolved NodeB (eNB), a next generation NodeB (gNB), a relay station, an access point, a transmitting and receiving point (TRP), a transmitting point (TP), a master station (MeNB), a secondary station (SeNB), a multistandard radio (MSR) node, a femtocell, a network controller, an access node, a wireless node, an access point (AP), a transmission node, a transceiver node, a base band unit (BBU), a remote radio unit (RRU), an active antenna unit (AAU), a remote radio unit (RRH), a central unit (CU), a distributed unit (DU), a positioning node, and the like. The base station may be a macro base station, a micro base station, a relay node, a donor node or the like, or a combination thereof. The base station may further refer to a communication module, a modem, or a chip disposed in the foregoing device or apparatus. The base station may also be a mobile switching center and a device that undertakes a function of the base station in D2D, V2X, M2M communication, a network side device in the 6G network, a device that undertakes a function of the base station in a future communication system, etc. The base station may support networks of the same or different access technologies. A specific technology adopted by the network device and a specific form of the device are not limited in the embodiments of the present disclosure.

The base station may be fixed or mobile. For example, a helicopter or drone may be configured to serve as a mobile base station, and one or more cells move according to the location of the mobile base station. In other examples, a helicopter or drone may be configured to serve as a device in communication with another base station.

In some deployments, the network device in the embodiments of the present disclosure may be a CU or a DU, or the network device includes a CU and a DU. The gNB may also include AAU.

As an example, and not limitation, the network device in the embodiments of the present disclosure may have a mobility characteristic, for example, the network device may be a mobile device. In some embodiments of the present disclosure, the network device may be a satellite or a balloon station. In some embodiments of the present disclosure, the network device may be a base station disposed at a location such as land, water, etc.

In the embodiments of the present disclosure, the network device may provide services for a cell, and the terminal device communicates with the network device via a transmission resource (e.g., a frequency domain resource, or a spectrum resource) used by the cell. The cell may be a cell corresponding to the network device (e.g., a base station), and the cell may belong to a macro base station or a base station corresponding to a small cell. The small cell may include a metro cell, a micro cell, a pico cell, a femto cell, etc., and these small cells have the characteristics of a small coverage and a low transmission power, which are suitable for providing a high-rate data transmission service.

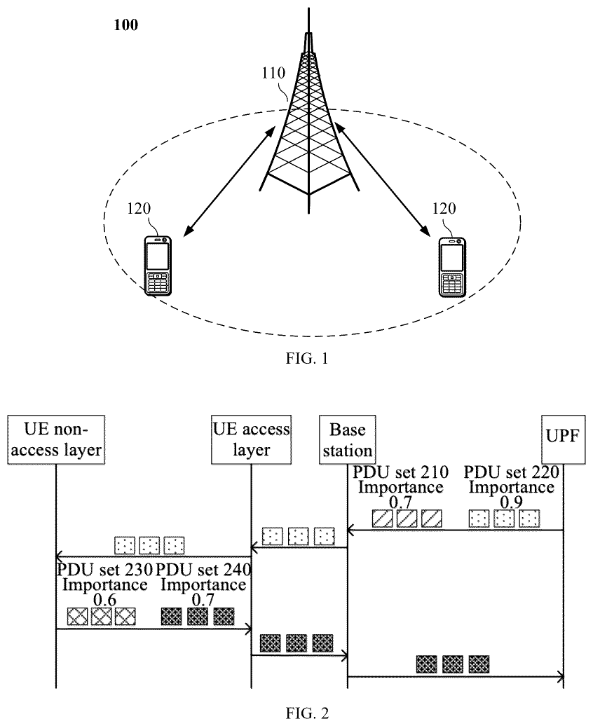

For example, FIG. 1 is a schematic architectural diagram of a communication system according to an embodiment of the present disclosure. As shown in FIG. 1, the communication system 100 may include a network device 110, and the network device 110 may be a device that communicates with a terminal device 120 (or referred to as a communication terminal or a terminal). The network device 110 may provide communication coverage for a particular geographic area and may communicate with a terminal device located within the coverage area.

FIG. 1 exemplarily shows a network device and two terminal devices. In some embodiments of the present disclosure, the communication system 100 may include a plurality of network devices, and the coverage of each network device may include other numbers of terminal devices, which is not limited in the embodiments of the present disclosure.

In the embodiments of the present disclosure, the wireless communication system shown in FIG. 1 may further include another network entity such as a mobility management entity (MME), an access and mobility management function (AMF), etc., which is not limited in the embodiments of the present disclosure.

It should be understood that a device having a communication function in the network/system in the embodiments of the present disclosure may be referred to as a communication device. Taking the communication system 100 shown in FIG. 1 as an example, the communication device may include the network device 110 and the terminal device 120 having the communication function, and the network device 110 and the terminal device 120 may be the specific devices described above and are not described here again. The communication device may further include another device in the communication system 100, e.g., another network entity such as a network controller, a mobility management entity, etc., which is not limited in the embodiments of the present disclosure.

For ease of understanding, some related technical knowledge in the embodiments of the present disclosure is first described. The following related technologies may be arbitrarily combined with the technical solutions of the embodiments of the present disclosure as an optional solution, which all belong to the protection scope of the embodiments of the present disclosure. The embodiments of the present disclosure include at least some of the following content.

With the continuous development of wireless cellular communication technology, the transmission capacity of networks is constantly being enhanced. This enhanced network transmission capacity has made some new types of services increasingly feasible. For example, with the advancement of 5G technology, spectrum efficiency is improving, available frequency bands are widening, and data transmission rates are increasing, which has facilitated the development of XR services.

The development of communication technology and new services promotes each other in a positive cycle. Taking the 5G network and XR service as an example, an XR service for a user requires a transmission rate of 30 to 200 Mbps and a cell must support at least 10 terminal devices simultaneously engaging in XR services, only the 5G network can provide such a large transmission capacity. On the other hand, the transmission capacity that a 5G cellular network can offer has significantly increased compared to previous wireless networks. Existing mainstream services cannot fill the network capacity, leading to underutilization of the network transmission capability, which objectively necessitates the introduction of a new service to fully use the 5G network, thereby promoting rapid growth and strengthening of the 5G network.

The ways that a new service and a traditional service organize transmission data are different. The traditional service organizes data in PDUs, while the new service typically organizes and transmits data in the form of a PDU set. Specifically, there is a very close relationship among a set of PDUs, which is referred to as the PDU set. If the sender only transmits part of the PDUs in a PDU set to the receiver, it does not enhance the user experience. Therefore, the communication network usually either attempts to successfully transmit all PDUs of a complete PDU set or transmits none at all. For example, in the XR service, video data is typically organized in the PDU set due to characteristics of video encoding.

To meet these requirements, the communication network has introduced the concept of PDU set importance. This means that the communication network can assign an importance parameter to a PDU set. When the network is congested and the sender cannot transmit all data packets, PDU sets with lower importance levels may be dropped first. For the downlink, the PDU set importance is indicated by a user plane function (UPF) of a core network to the base station. For the uplink, the PDU set importance is provided by an application layer of the terminal device. FIG. 2 shows a case in which the PDU set is transmitted based on the PDU set importance, and the data transmission occurs in the downlink and uplink of the UE, base station, and UPF.

Referring to FIG. 2, there are two PDU sets in the downlink sent from the UPF to the base station, namely PDU set 210 and PDU set 220. Each PDU set includes three PDUs, with an importance parameter of PDU set 210 being 0.7 and an importance parameter of PDU set 220 being 0.9. When a wireless interface is congested or of poor quality, the base station will determine which PDU sets to transmit to an access layer of the UE based on the importance parameters. Assuming that a higher importance parameter indicates greater importance, the base station will only transmit PDU set 220 and not PDU set 210, as shown in FIG. 2.

Continuing with FIG. 2, there are also two PDU sets in the uplink sent from the UE to the base station, namely PDU set 230 and PDU set 240. Each PDU set includes three PDUs, with an importance parameter of PDU set 230 being 0.6 and an importance parameter of PDU set 240 being 0.7. As shown in FIG. 2, when the UE cannot transmit all data packets, the access layer of UE will only transmit PDU set 240 to the base station and not PDU set 230.

From the above, it is seen that in the communication network, the sender communication device may be unable to transmit all PDU sets due to network congestion. In an actual transmission process, the receiver communication device may also fail to receive PDU sets for other reasons. In QoS statistics, the communication device needs to calculate a transmission error rate based on the PDU set.

To achieve the QoS statistics, the PDU set error rate (PSER) is introduced, i.e., the transmission error rate of the PDU set. PSER is a statistic of the transmission error rate in terms of PDU sets. Typically, the PSER statistic is performed by the terminal device (e.g., UE) side and the UPF side. The definition of PSER may be expressed as “a ratio of the number of PDU sets that have not successfully transmitted to a total number of PDU sets that needed to be transmitted,” or as “a ratio of the number of PDU sets that have not successfully transmitted under a condition that the network is not congested to the total number of PDU sets that needed to be transmitted.”

During the communication process, the sender knows all the PDU sets that need to be transmitted and can determine the number of dropped PDU sets. However, the receiver can only identify the PDU sets that have been received and cannot calculate the PSER. Therefore, how the receiver communication device calculates the PSER becomes an urgent problem to be solved.

To solve the above problem, it is necessary to analyze the reasons why the receiver cannot calculate the PSER. It should be noted that the present disclosure determines the solution exactly based on subsequent analysis of the reasons, which also belongs to the protection scope of the embodiments of the present disclosure.

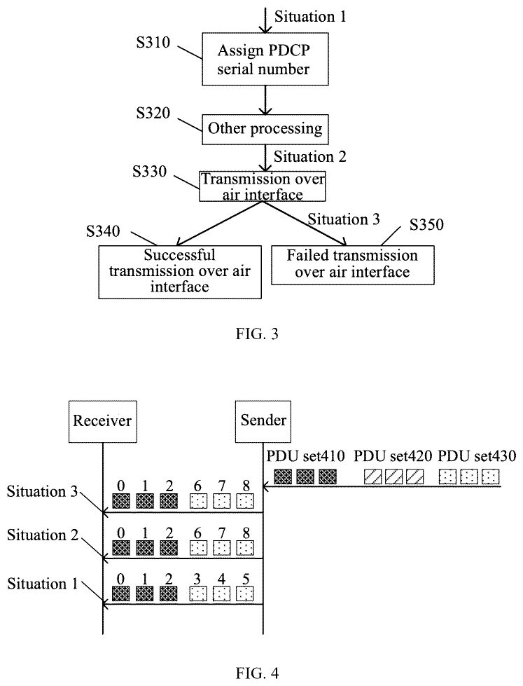

Analyzing the relevant transmission process, when a plurality of PDUs arrive at an access layer of the sender communication device, PDCP first assigns a PDCP serial number to each PDU, followed by other processing, and then transmits these PDUs to the receiver communication device via the wireless interface. When data is transmitted in units of PDU sets, the dropping of PDUs or PDU sets will result in the failure of the PDU set to be successfully transmitted. The receiver needs to identify the PDU sets that have not successfully transmitted among a plurality of PDU sets that arrived at the sender in order to calculate the PSER. Therefore, it is necessary to consider several situations in which PDU sets may fail to be successfully transmitted. The following introduces the situations in which the receiver cannot perform statistics of the failure of the plurality of PDU sets to be successfully transmitted with reference to FIG. 3.

Referring to FIG. 3, the processing of data by the sender communication device mainly includes three operations: operation S310, a packet data convergence protocol (PDCP) layer assigns PDCP serial numbers (SN); operation S320, other processing; and operation S330, air interface transmission. At operation S340, the dropping of packets has not occurred, and the air interface transmission is successful. At operation S350, the dropping of packets has occurred, and the air interface transmission fails. Situations 1 to 3 in FIG. 3 respectively illustrate three situations that lead to the failure of PDU sets to be successfully transmitted during the transmission process.

As shown in FIG. 3, in Situation 1, the sender communication device drops the PDU set required to be transmitted before operation S310. For example, if the network congestion occurs, the base station or UE may drop the PDU set upon receiving it from the upper layer, without assigning PDCP SNs to the PDUs within the PDU set.

In Situation 2, the sender communication device drops the PDU set required to be transmitted after operation S320. For example, if network congestion occurs during the transmission of a PDU set, the sender may drop some PDUs that are not transmitted within this PDU set.

In Situation 3, one or more PDUs within the PDU set may be dropped due to poor link quality during over-the-air transmission. This means the dropping of the PDU set may occur after operation S330.

The above describes three situations in which the PDU set may not be successfully transmitted in conjunction with FIG. 3. For easy of understanding, the following provides examples to describe the three situations with reference to FIG. 4.

With reference to FIG. 4, the sender sends three PDU sets, i.e., PDU set 410, PDU set 420, and PDU set 430 to the receiver, each including three PDUs. As shown in FIG. 4, due to the dropping of the PDU set, the receiver only receives PDU set 410 and PDU set 430. This means PDU set 420 has not successfully transmitted. The data above each PDU in the successfully transmitted PDU sets represents its PDCP serial number. Three situations of the transmission between the sender and the receiver in FIG. 4 correspond to the three situations where the dropping occurs in FIG. 3.

In Situation 1, the sender drops the data packets before operation S310 in FIG. 3, so no PDCP serial numbers are assigned to the PDUs in PDU set 420. The PDCP serial numbers of the packets received by the receiver are 0-1-2-3-4-5. For the receiver, it cannot determine from the PDCP serial numbers that there are PDU sets not correctly transmitted.

In Situation 2, the sender assigns PDCP serial numbers to PDU set 420 at operation S310 in FIG. 3 but drops it after operation S320. The PDCP serial numbers of the packets received by the receiver are 0-1-2-6-7-8. For the receiver, it knows some PDUs are not received based on the PDCP serial numbers but cannot determine how many PDU sets are not correctly received.

In Situation 3, the sender assigns PDCP serial numbers to PDU set 420 at operation S310 in FIG. 3 and transmits it over the air interface at operation S330, but the transmission fails. Similar to Situation 2, the PDCP serial numbers of the packets received by the receiver are 0-1-2-6-7-8. Likewise, the receiver knows some PDUs are not received based on the PDCP serial numbers but cannot determine how many PDU sets are not correctly received.

For Situations 2 and 3 in FIGS. 3 and 4, if the receiver finds that the PDCP serial numbers of the received PUDs are discontinuous after receiving data, it is determined that the dropping of the packet has occurred. However, the receiver only knows that some PDUs have not successfully received but cannot determine how many PDU sets have not successfully received. The current solution proposes a way to assign serial numbers to PDU sets, but the receiver still cannot accurately calculate the PSER. For ease of understanding, the following describes a situation where PSER statistics cannot be obtained by the receiver based on the PDCP serial number and PDU set serial number in combination with the example shown in FIG. 5. FIG. 5 shows a situation in which the receiver is unable to determine whether the transmission of the received PDU set is successful.

With reference to FIG. 5, the sender sends 6 PDUs with assigned PDCP serial numbers, ranging from 0 to 5. The serial numbers of PDU sets corresponding to the 6 PDUs are N and N+1. During transmission, two PDUs with PDCP serial numbers 2 and 3 are dropped, so PDCP serial numbers received by the receiver are 0, 1, 4, and 5, where packets 0 and 1 correspond to the PDU set serial number N and packets 4 and 5 correspond to the PDU set serial number N+1. Additionally, there may be three situations as shown in FIG. 5. To distinguish between Situations 1 to 3 in FIG. 3 and FIG. 4, the three situations in FIG. 5 are labeled as Situations 4 to 6.

In Situation 4, the unsuccessfully received packets 2 and 3 belong to different PDU sets, resulting in two PDU sets not being successfully received. As shown in FIG. 5, packet 2 belongs to a PDU set with serial number N and packet 3 belongs to a PDU set with serial number N+1.

In Situation 5, both unsuccessfully received packets 2 and 3 belong to the PDU set with serial number N+1, so the receiver can conclude that only one PDU set has not been successfully received.

In Situation 6, both unsuccessfully received packets 2 and 3 belong to the PDU set with serial number N, so the receiver can similarly conclude that only one PDU set has not been successfully received.

Due to the existence of Situations 4 to 6, the receiver cannot determine the number of unsuccessfully transmitted PDU sets based solely on the PDCP serial numbers and the PDU set serial numbers. Therefore, there is no solution for the receiver to determine the “number of unsuccessfully transmitted PDU sets” and subsequently calculate the PSER.

In Situation 1 from FIG. 3 and FIG. 4, the PDCP serial numbers of the received PDUs are continuous. The receiver cannot know that there are PDUs that have not been successfully transmitted, and thus cannot determine the “number of unsuccessfully transmitted PDU sets,” making it impossible to calculate the PSER.

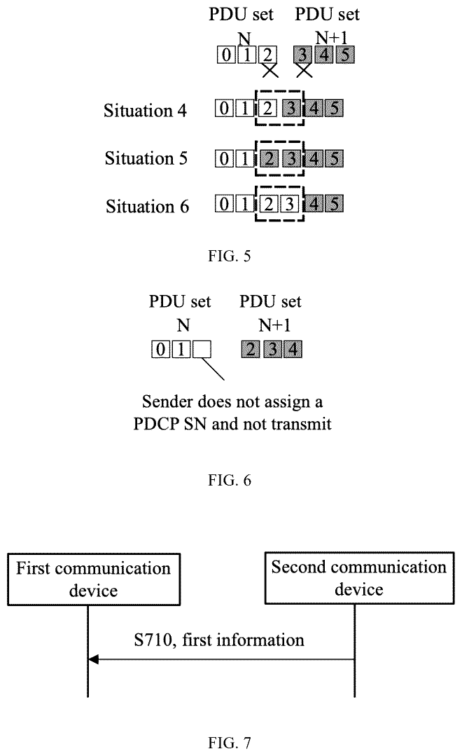

After assigning serial numbers to the PDU sets, even when both the PDU set serial numbers and PDCP serial numbers are continuous, the receiver may still be unable to determine the “number of unsuccessfully transmitted PDU sets.” In actual transmission process, when the sender has already transmitted part of PDUs in a PDU set, the sender may stop transmitting the remaining PDUs in that PDU set if a sudden congestion occurs or the air interface deteriorates. In such cases, the sender may not assign PDCP serial numbers for the remaining PDUs in the PDU set. The sender may wait until the network congestion is resolved before transmitting a next PDU set and continue assigning PDCP serial numbers. To facilitate understanding, this case is described in conjunction with FIG. 6.

Taking the situation shown in FIG. 6 as an example, the sender also sends 6 PDUs, and serial numbers of PDU sets corresponding to the 6 PDUs are N and N+1. The PDU set with serial number N encounters network congestion during transmission, and the sender does not assign a PDCP serial number for the third PDU of this PDU set. In other words, after the sender has sent PDUs 0 and 1, the last packet of the PDU set with serial number N is not assigned a PDCP serial number and is abandoned to be transmitted. Once the congestion is lifted, the sender directly assigns PDCP serial numbers 2, 3, and 4 for PDUs in the PDU set with serial number N+1. For the receiver, the received PDCP serial numbers are continuous, and the PDU set serial numbers are also continuous. As mentioned above, if only part of the PDUs in a PDU set are transmitted, it does not enhance the user experience. Therefore, the PDU set with serial number N has not been successfully transmitted. However, the receiver cannot count the unsuccessfully received PDU set with serial number N when calculating the PSER, which means the receiver cannot obtain the PSER statistics.

Based on the analysis of the issues and reasons in conjunction with FIG. 3 to FIG. 6, the present disclosure provides a method for wireless communication. Through this method, the receiver communication device determines the “number of unsuccessfully transmitted PDU sets” based on first information, thereby accurately calculating the PSER based on the PDU sets. The following describes the method provided in the present disclosure in detail in conjunction with FIG. 7.

The method shown in FIG. 7 is introduced from a perspective of interaction between a first communication device and a second communication device. Both the first communication device and the second communication device may be any one of the terminal devices or the network devices mentioned above. In some embodiments, the first communication device may be a terminal device, and the second communication device may be a network device. In some embodiments, the first communication device may be a network device, and the second communication device may be a terminal device. In some embodiments, the first communication device and the second communication device may both be terminal devices.

As shown in FIG. 7, the first communication device is a receiver of the communication link, and the second communication device is a sender of the communication link. The communication link may be determined based on a type of the first communication device and a type of the second communication device. For example, when the second communication device is a network device, and the first communication device is a terminal device, the communication link is a downlink. For another example, when the first communication device is a network device, and the second communication device is a terminal device, the communication link is an uplink.

Referring to FIG. 7, at operation S710, the first communication device receives first information.

The first information may be used for the first communication device to determine a PDU set error rate. It should be noted that the PDU set error rate is the PSER described above. In the present disclosure, statistics of the PDU set error rate may be applied to various transmission processes that perform data transmission and statistics using a packet set. For simplicity, the PDU set error rate will be represented by PSER in the following.

The PSER determined by the first communication device corresponds to the PDU set(s) that the second communication device needs to transmit to the first communication device by. That is, the calculation of the PSER is based on a number of PDU sets that need to be transmitted by the second communication device.

The PDU set to be transmitted by the second communication device may be one or more. The number of one or more PDU sets to be transmitted by the second communication device may be determined according to transmission requirements. In some embodiments, the number of PDU sets that all need to be transmitted by the second communication device may be all PDU sets that arrive at an access layer of the second communication device or may be a part of the PDU sets that arrive at the second communication device. For example, when the second communication device is the UE, the PDU sets required to be transmitted are all PDU sets that arrive at the access layer from a non-access layer. For example, when the second communication device is a base station, the PDU sets required to be transmitted are all PDU sets sent from the UPF to the base station. For example, when a plurality of PDU sets arrive at the access layer of the second communication device, the second communication device may not intend to transmit a portion of the PDU sets. In this case, the second communication device typically does not assign PDCP serial numbers to PDUs in this portion of PDU sets, but instead deletes them directly. The PDU sets all of which the second communication device needs to transmit do not include this portion of PDU sets that are not intended to be transmitted.

In some embodiments, the one or more PDU sets used to calculate the PSER are the PDU set(s) that the second communication device needs to transmit to the first communication device. For example, when the second communication device is a base station, the PDU set transmitted by the UPF to the base station may correspond to a plurality of terminal devices. When calculating the PSER, the first communication device only needs to consider the number of PDU sets that the base station needs to send to the first communication device.

In some embodiments, the one or more PDU sets used to calculate the PSER may be all PDU sets obtained by the second communication device. In other words, when calculating the PSER, the first communication device may use the number of all PDU sets obtained by the second communication device as a calculation basis. For example, in the downlink, the second communication device is a base station, and the first communication device may consider the “PDU set directly deleted by the base station” as instructed when calculating the PSER.

When calculating the PSER, the first communication device needs to determine a number of unsuccessfully transmitted PDU sets or a number of successfully transmitted PDU sets, and a number of PDU sets that need to be transmitted by the second communication device. The statistic of PSER may be obtained in a plurality of manners, which is not limited herein. In some embodiments, the PSER may be determined by the number of unsuccessfully transmitted PDU sets and the number of PDU sets that need to be transmitted. For example, the PSER may refer to a proportion of the unsuccessfully transmitted PDU sets in all PDU sets that need to be transmitted. In some embodiments, the PSER may be determined by the number of successfully transmitted PDU sets and the number of PDU sets that need to be transmitted. For example, the PSER may refer to a proportion of the successfully transmitted PDU sets in all PDU sets that need to be transmitted.

As described above, in the transmission process, the first communication device cannot determine the parameters for calculating the PSER according to the received data packet. The second communication device may send the first information to the first communication device. The first communication device may calculate the PSER based on the first information.

The first information may include one or more of: second information corresponding to the one or more PDU sets; a number of the one or more PDU sets; and a number of unsuccessfully transmitted PDU sets in the one or more PDU sets. The one or more PDU sets may have the number of PDU sets that need to be transmitted by the second communication device as described above. Each PDU set that needs to be transmitted by the second communication device may be referred to as a first PDU set.

In some embodiments, the first information may include the second information corresponding to the PDU sets. The second information may include detailed information of transmitted PDU sets, which is used for the first communication device to determine whether a received PDU set is successfully transmitted. Successful transmission of a PDU set refers to that the first communication device successfully receives all data packets of the PDU set. The detailed information may correspond to the first PDU set. The detailed information of the first PDU set may also be referred to as indication information, or additional information of the PDU set.

As a possible implementation, the indication information may include one or more of a number of PDUs included in the first PDU set, a number of bits or bytes included in the first PDU set, a start PDCP serial number of the PDUs included in the first PDU set, and an end PDCP serial number of the PDUs included in the first PDU set.

For example, the indication information may include the number of PDUs included in the first PDU set and the start/end PDCP serial number of the PDUs included in the first PDU set. The first communication device determines all PDCP serial numbers corresponding to the first PDU set based on the number of PDUs and the start/end PDCP serial number of the PDUs, so as to determine whether the received PDU set contains all PDUs, thereby determining whether the transmission is successful.

For example, the indication information may include the number of bits/bytes included in the first PDU set as well as the start/end PDCP serial number. The first communication device may locate the first PDU set using the start/end PDCP serial number, and then determine whether the first PDU set is successfully transmitted based on the number of bits/bytes.

For example, the indication information may include the start serial number and the end PDCP serial number of the PDUs in the first PDU set. The first communication device may determine the number of PDUs in the first PDU set based on the start and end PDCP serial numbers, thus determining whether there is any packet loss in the received first PDU set.

The indication information may be used for the first communication device to determine whether it successfully received all packets of a PDU set, allowing it to count the PDU sets that are not successfully transmitted. However, the first communication device cannot count the PDU sets that are not received. In this case, the second information may further include a PDU set serial number (SN) set by the sender for each PDU set. The first communication device may determine whether there is any PDU set that is not transmitted based on the continuity of PDU set serial numbers. In other words, the first communication device may determine the “number of PDU sets in which not all PDUs are successfully transmitted,” according to the second information, thereby calculating the PSER. The following will describe in detail in conjunction with the assigning of serial numbers.

In some embodiments, the second communication device may send the indication information to the first communication device in various ways. As a possible implementation, the indication information may be notified to the first communication device via a PDCP control PDU, or via a PDCP header. As an implementation, the second communication device may notify the first communication device via the PDCP control PDU. This PDCP control PDU may be inserted at any position within the PDU set or may be located outside a current PDU set. For example, the PDCP control PDU carrying the indication information may be inserted at the very beginning and/or the very end of the PDU set. As another implementation, the second communication device may also notify the first communication device via the PDCP header. The indication information may be carried in the PDCP headers of one or more PDUs within the first PDU set. For example, a PDU corresponding to the PDCP header carrying the indication information may be the first PDU and/or the last PDU.

When the second information includes the PDU set serial numbers and indication information, transmitting the second information over the air interface increases the air interface load. To reduce the air interface load, the second information may not be transmitted. Instead, an additional notification manner may be adopted to directly notify the first communication device of whether any PDU sets have been deleted or dropped. In other words, the second communication device may directly indicate the transmission status of one or more PDU sets to the first communication device through the first information. Specifically, the first information may only send an additional notification indicating an actual transmission status. Since the additional notification occupies fewer bytes and does not need to be transmitted for each PDU set, the air interface load can be reduced when sending this first information. For example, the first information may be set to be transmitted once for multiple PDU sets or may be set to be transmitted once only when packet loss occurs.

In some embodiments, the first information may include the number of one or more PDU sets. That is to say, the first information received by the first communication device may directly indicate the number of PDU sets that the second communication device needs to transmit. The first communication device may calculate the PSER based on the number of received PDU sets and the parameter.

In some embodiments, the first information may include the number of unsuccessfully transmitted PDU sets in the one or more PDU sets. This means that the first information received by the first communication device may directly indicate the number of unsuccessfully transmitted PDU sets. The first communication device may determine the number of PDU sets that need to be transmitted based on the number of received PDU sets and the number of unsuccessfully transmitted PDU sets, thereby calculating the PSER.

As shown in FIG. 7, the first communication device, as the receiver, may determine the details of each PDU set or the transmission status of all PDU sets through the first information, thus accurately calculating the PSER.

As mentioned above, the second information, in addition to including indication information, may further include the PDU set serial numbers assigned by the second communication device for each PDU set, in order to count the unsuccessfully transmitted PDU sets. To distinguish from the PDCP serial numbers of the PDUs in the PDU sets, the serial number of the PDU set may be referred to as a first serial number. The second communication device, as the sender, may assign first serial numbers to PDU sets that need to be transmitted and assign PDCP serial numbers to PDUs within the PDU sets.

In some embodiments, the second information may include first serial numbers assigned by the second communication device to PDU sets and PDCP serial numbers assigned by the second communication device to PDUs in the PDU sets. The first communication device may determine the number of unsuccessfully transmitted PDU sets based on first serial numbers of received PDU sets and/or PDCP serial numbers of received PDUs. The received PDU sets may be all the PDU sets received by the first communication device. These PDU sets may include successfully transmitted PDU sets or may also include unsuccessfully transmitted PDU sets. The received PDUs may be all the PDUs received by the first communication device.

As a possible implementation, the first communication device may make a preliminary judgment on the transmission status of the PDU sets that need to be transmitted based on the continuity of the received first serial numbers and PDCP serial numbers.

For example, if the first serial numbers received by the first communication device are discontinuous, the first communication device determines the number of unsuccessfully transmitted PDU sets in one or more PDU sets based on the received first serial numbers. In other words, if the first serial numbers are discontinuous, the first communication device may determine how many PDU set serial numbers are missing, thus determining that at least several PDU sets are not successfully received. In the case of discontinuous first serial numbers, the first serial numbers can help the first communication device identify the PDU sets that are dropped.

For example, the second communication device assigns a respective PDU set serial number to each PDU set and transmit the PDU set serial number along with the PDCP header to the first communication device. If the first communication device finds that the PDU set serial numbers in the PDCP headers of the received PDUs are discontinuous, it is considered that the PDU set loss occurs, thus counting it as an “unsuccessfully transmitted PDU set.”

Exemplarily, if the first serial numbers received by the first communication device are continuous, the first communication device determines the number of unsuccessfully transmitted PDU sets in one or more PDU sets based on the second information mentioned above. In other words, in the case of continuous first serial numbers, the first communication device can determine that at least one PDU from the PDU sets that need to be transmitted has been received. As previously mentioned, the first communication device determines whether the received PDU sets are transmitted successfully based on the indication information. Table 1 summarizes various cases for determining whether the transmission is successful based on serial numbers as discussed above.

TABLE 1

| | Status of serial number | Determination result |
|---|---|---|
| 1 | PDU set serial numbers | several PDU set |
| | are discontinuous | serial numbers are |
| | | missing, i.e., it |
| | | is considered that |
| | | several PDU sets are not |
| | | successfully received |
| 2 | 2.1 PDU set serial | |
| | numbers are continuous, | |
| | PDCP serial numbers | |
| | are discontinuous | |
| | 2.2 PDU set serial | all PDU sets |
| | numbers are continuous, | are successfully |
| | PDCP serial numbers | received |
| | are continuous | |

Referring to Table 1, if the PDU set serial numbers are continuous and the PDCP serial numbers are continuous, the first communication device considers all PDU sets successfully received, i.e., case 2.2 in Table 1. If the PDU set serial numbers are continuous, but the PDCP serial numbers are discontinuous, the first communication device further determines whether the PDU sets were correctly received based on the received PDU set information, i.e., case 2.1 in Table.

For case 2, if the receiver finds that the PDU set serial numbers of received data packets are continuous, the receiver further determines whether the PDU sets are correctly received based on other information. This other information may be the indication information described above or the PDCP serial numbers. Specifically, when the first serial numbers are continuous, the first communication device may further classify the transmission status into two types based on the continuity of the PDCP serial numbers, i.e., the PDCP serial numbers being continuous and the PDCP serial numbers being discontinuous like cases 2.1 and 2.2 in Table 1.

For case 2.1, the first serial numbers are continuous, the PDCP serial numbers are discontinuous, the first communication device may determine the unsuccessfully transmitted PDU sets in the one or more PDU sets according to the indication information. The first PDU set corresponding to the indication information is determined based on the PDUs with discontinuous PDCP serial numbers. In other words, the first communication device may determine a first PDU set of which the transmission potentially fails based on the missing PDCP serial numbers, and then determine whether the complete data packets of the first PDU set are received based on the corresponding indication information. Taking FIG. 5 as an example, when the first communication device finds that the missing PDCP serial numbers are 2 and 3, due to that the PDU with a PDCP serial number before PDCP serial number 2 corresponds to PDU set N and the PDU with a PDCP serial number after PDCP serial number 3 corresponds to PDU set N+1, the first PDU sets that the first communication device needs to determine whether they are successfully transmitted include two PDU sets, i.e., PDU set N and PDU set N+1. The first communication device may determine, based on the indication information of the two PDU sets, which situation shown in FIG. 5 the two PDU sets belong to, so as to determine the unsuccessfully transmitted PDU sets.

For case 2.2, typically, when both the first serial numbers and the PDCP serial numbers are continuous, all PDU sets are considered successfully received. However, as shown in FIG. 6, PDUs may be dropped even when the PDCP serial numbers are continuous. There are two solutions for this case.

Solution 1: when receiving continuous first serial numbers and continuous PDCP serial numbers, the first communication device may determine the unsuccessfully transmitted PDU sets based on the number of PDUs, bits, or bytes in the received PDU sets. As mentioned above, this information may be included in the indication information. Taking FIG. 6 as an example, the first communication device may infer that the PDU set with serial number N is not successfully received based on the additional information “the number of PDUs in a PDU set” or “number of bytes in a PDU set,” and then calculate the PSER.

Solution 2: the PDCP serial numbers of the PDUs in one or more PDU sets are assigned in terms of PDU sets. For the sender, the second communication device can only assign PDCP serial numbers in terms of PDU sets. That is, within a PDU set, either all PDUs are assigned PDCP serial numbers, or none are assigned PDCP serial numbers. The case where “some PDUs in the same PDU set are assigned PDCP SNs, while others are not” is not allowed, thus preventing the case shown in FIG. 6. As a possible implementation, the protocol can specify that the sender assigns PDCP serial numbers in terms of PDU sets.

Similar to the indication information, the second information including the indication information and other information may be transmitted via the PDCP control PDU and/or the PDCP header, which is not repeated herein. Additionally, the second information may also be transmitted via the medium access control control element (MAC CE).

When the first information includes the second information of the PDU set, the second communication device may assist the first communication device in correctly determining the unsuccessfully transmitted PDU sets by notifying the first communication device of the PDU set serial numbers and other information regarding the PDU sets. As mentioned above, when the amount of information contained in the second information is large, the overhead for transmission over the air interface is significant. To reduce transmission overhead, embodiments of the present disclosure also provide a method for the first communication device to calculate the PSER. This method directly indicates the transmission status of all PDU sets to the first communication device through the first information.

In some embodiments, when the first information indicates the number of unsuccessfully transmitted PDU sets in the one or more PDU sets, the first communication device determines the number of PDU sets that need to be transmitted based on the first information and the number of received PDU sets, so as to determine the PSER.

For the second communication device as the sender, it may determine the unsuccessfully transmitted PDU sets based on an actual transmission status and/or transmission feedback of the PDU sets, and send the number of unsuccessfully transmitted PDU sets through the first information. The number of unsuccessfully transmitted PDU sets may be directly indicated by sending “X PDU sets not transmitted,” or cumulatively indicated by sending multiple messages stating “one PDU set not transmitted.” Here, X represents the number of PDU sets. In other words, when the second communication device determines that X (where X is an integer greater than 0) PDU sets are not successfully transmitted, it sends X third information to the first communication device, where the third information indicates that one PDU set is not successfully transmitted; alternatively, it sends fourth information to the first communication device, where the fourth information indicates that X PDU sets are not successfully transmitted.

As a possible implementation, the second communication device assigns PDCP serial numbers to the PDU sets. If the PDU sets are not transmitted over the air interface due to sudden network congestion or for other reasons, the second communication device notifies the first communication device that “one PDU set is not transmitted.” The first communication device counts the PDU set that is not correctly received into the PSER if it notices that the received PDCP serial numbers are discontinuous and receives the notification “one PDU set is not transmitted.”

As another possible implementation, the second communication device may transmit a PDU set over the air interface but may receive feedback at a lower layer indicating that all transport blocks (TB) corresponding to that PDU set were not successfully transmitted. For example, the second communication device may receive feedback through HARQ indicating that all TBs corresponding to the PDU set have failed. In this case, the second communication device may also generate a notification “one PDU set is not transmitted” to notify the first communication device. From the perspective of the first communication device, whether the PDU set is assigned a PDCP serial number but fails to be transmitted or is assigned a PDCP serial number but is not transmitted over the air interface, the result is the same, and the first communication device counts this PDU set into PSER.

As another possible implementation, when the second communication device assigns PDCP serial numbers to the PDU sets, it may not assign PDCP serial numbers to some or all of the PDU sets if the network suddenly becomes congested or for other reasons. In this case, the second communication device may also notify the first communication device that “one PDU set is not transmitted.” The first communication device notices that the received PDCP serial numbers are discontinuous but receives the notification “one PDU set is not transmitted,” it may count that PDU set into the PSER. The first communication device may also determine whether to count that PDU set into the PSER based on configuration information of a network device.

In some embodiments, the second communication device may also indicate the transmission status of the unsuccessfully transmitted PDU sets to the first communication device via the first information. The transmission status may include one of three situations shown in FIG. 3 and FIG. 4. Specifically, the transmission status includes one of: PDUs in the unsuccessfully transmitted PDU sets being not assigned PDCP serial numbers; the PDUs in the unsuccessfully transmitted PDU sets having PDCP serial numbers but being not transmitted; and the PDUs in the unsuccessfully transmitted PDU sets having PDCP serial numbers but the transmission being failed.

Exemplarily, the PDCP serial numbers are assigned in the latter two situations, so the second communication device may also generate different notifications for the two situations. For example, the second communication device may notify the first communication device of “a PDU set is assigned a PDCP serial number but not transmitted” or “a PDU set is assigned a PDCP serial number, transmitted, but the transmission is failed.”

As a possible implementation, when the second communication device directly sends “X PDU sets are not transmitted” to the first communication device, it may also indicate how many of the X PDU sets fall into each of the above three situations, allowing the first communication device to determine the actual transmission status of the unsuccessfully transmitted PDU sets.

Several methods for determining the actual transmission status of the PDU sets are described above. Upon receiving different notifications, the first communication device may determine whether to use the unsuccessfully transmitted PDU sets to calculate the PSER based on the transmission status of the unsuccessfully transmitted PDU sets and the configuration information of the network device. When the first communication device is a terminal device, the second communication device as a network device sends configuration information to the first communication device. This configuration information is used for the first communication device to determine whether to use the unsuccessfully transmitted PDU sets to calculate the PSER based on the transmission status of the unsuccessfully transmitted PDU sets. The terminal device may receive the configuration information sent by the network device and calculate the PSER based on the configuration information and the transmission status of the PDU sets. When the first communication device is a network device, the first communication device may independently decide whether to use the unsuccessfully transmitted PDU sets in calculating the PSER.

Exemplarily, when the first communication device receives the two different notifications, i.e., “a PDU set is assigned a PDCP SN but not transmitted” or “a PDU set is assigned a PDCP SN, transmitted, but the transmission is failed,” whether the PDU set is included in the PSER is configured by the network device. When the first communication device is a terminal device, the network device can configure this via an RRC message. When the first communication device is a base station, the base station may decide independently whether to include the PDU set in the PSER, or this may be determined by the UPF.

Exemplarily, when the second communication device determines that a PDU set is not successfully transmitted, it may directly notify the first communication device “whether the unsuccessfully transmitted PDU set is included in the PSER”. The first information may include this notification, and this notification may be sent as an in-band notification. For example, after determining that a second PDU set is not successfully transmitted, the second communication device may send fifth information to the first communication device. This fifth message may be used to indicate whether the second PDU set is used to calculate the PSER.

In some embodiments, when the first information indicates the number of one or more PDU sets, the first communication device may determine the PSER based on the first information and the number of received PDU sets. That is, when the first information directly indicates the number of PDU sets that the second communication device needs to transmit, the first communication device may calculate the PSER directly based on the number of received PDU sets. For the second communication device, the sent first information may include “the number of PDU sets that have been assigned PDCP SNs.” After receiving this information, the first communication device may calculate the number of unsuccessfully received PDU sets based on the number of successfully received PDU sets, and then further calculate the PSER. It should be noted that the second communication device needs to be configured to assign PDCP SNs to all PDU sets that need to be transmitted. That is, regardless of whether network congestion occurs or whether to transmit on the air interface, PDCP SNs should be assigned to all PDU sets that need to be transmitted.

As a possible implementation, the first communication device may determine the number of successfully received PDU sets based on the aforementioned indication information, thereby determining the number of unsuccessfully transmitted PDU sets.

As another possible implementation, the first information includes the number of one or more PDU sets, and the second communication device may assign PDCP serial numbers to the PDUs in all PDU sets that need to be transmitted and then sends the number of PDU sets with assigned PDCP serial numbers to the first communication device.

The above manner of directly indicating the transmission status based on the first information introduces various types of information that assist the first communication device in calculating PSER. During the transmission process, the second communication device may determine the timing for sending the first information based on actual transmission needs, to efficiently utilize time frequency resources of the wireless network. In other words, the first information may be sent in various ways. For example, the second communication device may send the first information at a periodicity of a first time interval. For example, the second communication device may send the first information based on an event trigger. When sending based on the event trigger, the second communication device may send the first information or trigger the sending of the first information within a certain time window.

In some embodiments, the second communication device may send the first information to the first communication device in real-time. As a possible implementation, the second communication device may immediately send the first information upon discovering that transmission of a certain PDU set has failed. For example, when the second communication device finds that the transmission of all TBs of a certain PDU set has failed, subsequent PDU sets may have already begun transmission, and the second communication device may transmit during the transmission of the subsequent PDU sets. As another possible implementation, the second communication device may send the first information as soon as it determines that a certain PDU set cannot be transmitted. For example, while sending a certain PDU set, the second communication device may find that the network is too congested or the wireless link quality is too poor to transmit a next PDU set, and the second communication device may generate a notification of the first information and send it during the transmission of this PDU set.

In some embodiments, the second communication device may send the first information in a non-real-time notification manner. During actual transmission, the occurrence of dropped PDU sets typically indicates that the wireless link quality has deteriorated or that higher-priority data needs to be transmitted. In such cases, notifying the first communication device in real-time may be costly. Therefore, the second communication device may wait until the wireless link quality improves or the transmission of higher-priority data is completed before notifying the first communication device about the transmission status of the dropped PDU sets. For example, the second communication device may notify that “there are PDU sets being dropped,” or “there are X PDU sets being dropped,” or “there are all/part of X PDU sets being dropped.” Additionally, since the first communication device only uses this information to calculate PSER, even if the notification is not real-time, this does not affect the calculation of the first communication device.

As a possible implementation, the second communication device may send the first information or trigger the sending of the first information to the first communication device within a first time window. Accordingly, the first communication device may receive the first information sent by the second communication device within the first time window. When the second communication device triggers the sending of the first information within the first time window, the first communication device may determine the time of receiving the first information within the first time window. A start time of the first time window may be determined based on the time of the event trigger. For example, the first time window may be determined based on the time when the second communication device determines that a PDU set is not successfully transmitted. The time of the PDU set being not unsuccessfully transmitted may refer to a time when the second communication device determines that the PDU set cannot be transmitted or the time when the second communication device determines, based on feedback, that the transmission of the PDU set has failed. Exemplarily, the first time window may also be determined based on the time when the second communication device determines the number of PDU sets that need to be transmitted.

As a possible implementation, parameters of the first time window may be determined based on a configuration of the network device. The parameters of the first time window may include a time domain range of the first time window. That is, when the second communication device is a base station, a specific value of the first time window may be defined by the base station itself. When the second communication device is a terminal device, the specific value of the first time window may be configured by the base station via radio resource control (RRC) messages.

For example, the network device may configure a corresponding first time window for each terminal device, each radio bearer (RB), each flow, or each PDCP entity. When the network device configures the first time window in terms of flow, if multiple flows map to the same RB and their first time windows have different values, a first time window of this RB may adopt the maximum/minimum time window among the first time windows of the multiple flows.

For example, for the uplink, the terminal device may choose to send or trigger a notification including the first information within a time window window_ind_UL after the dropping of a PDU set. If the window_ind_UL is exceeded, the terminal device may cease sending or triggering the notification, or may configure other sending times. A specific value of window_ind_UL is defined by the base station and configured via RRC messages. The base station may configure a window_ind_UL for each terminal device, RB, flow, or PDCP entity via RRC messages. For another example, for the downlink, the base station may choose to send or trigger a notification including the first information within a time window window_ind_DL after the dropping of a PDU set. If the window_ind_DL is exceeded, the base station may cease sending or triggering the notification, or may configure other sending times. A specific value of window_ind_DL is defined by the base station itself.

In some embodiments, the second communication device may periodically notify the first communication device of the first information. As a possible implementation, the second communication device may periodically notify the “number of unsuccessfully transmitted PDU sets.” This notification may represent the number of unsuccessfully transmitted PDU sets within the current period or a cumulative number of unsuccessfully transmitted PDU sets since service establishment. As another possible implementation, the second communication device may periodically notify the “number of PDU sets with assigned PDCP SNs.” This notification may represent a number of all PDU sets the second communication device needs to transmit. For the uplink, the period may be determined by the base station and configured via RRC messages. For the downlink, the period may be determined by the base station itself.

As an example, the second communication device may send first information to the first communication device at a periodicity of a first time interval. The first information may be used to indicate a number of unsuccessfully transmitted PDU sets within a first time interval, or a number of unsuccessfully transmitted PDU sets within multiple first time intervals. A specific value of the first time interval may be determined based on a configuration of the network device.

As an example, when the second communication device assigns PDCP serial numbers to PDUs in all PDU sets that need to be transmitted, the second communication device may send the number of PDU sets with assigned PDCP serial numbers to the first communication device at a periodicity of a second time interval. A specific value of the second time interval may also be determined based on the configuration of the network device. The values of the second time interval and the first time interval may be the same or different.

In some embodiments, the first information may be carried within various types of information, including the RRC signaling, PDCP control PDU, MAC CE, and PDCP header of the transmitted PDU. For example, when the first information is used to indicate the number of unsuccessfully transmitted PDU sets, the first information may be carried within the PDCP header of normally transmitted PDUs.

As described above, the PSER is calculated by the terminal device (e.g., UE) and the UPF. In the downlink, the UE is the receiver on the wireless interface, which may directly calculate the PSER based on the first information and/or the indication information of the PDU set. In the uplink, the base station (e.g., gNB) is the receiver on the wireless interface, which needs to communicate with the UPF to calculate the PSER.

In some embodiments, when the first communication device is the base station, the UPF corresponding to the base station may determine the PSER in one of the following ways: based on the PSER sent by the base station; and based on transmission information sent by the base station. When the base station directly calculates the PSER, the transmission overhead between the base station and the UPF is reduced.

As an example, the UPF may determine the PSER in the following two ways. 1. It is considered that the transmission between gNB and UPF is 100% reliable, and gNB directly calculates PSER and notifies UPF. 2. After the gNB obtains the transmission details of the PDU sets, it notifies the UPF for the UPF to calculate the PSER.

The method provided in the embodiments of the present disclosure allows the sender communication device to notify the receiver communication device of the “number of dropped PDU sets” and additional information of the PDU set. The receiver communication device may then calculate the PSER based on the related information. Furthermore, regardless of where the sender communication device drops the PDU sets or fails to transmit the PDU sets, the receiver communication device is able to accurately calculate the PSER.

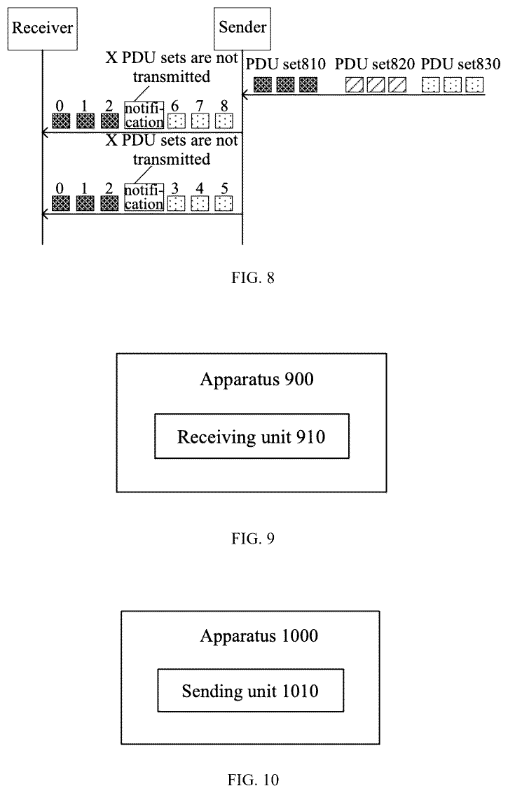

To facilitate understanding, the following provides an exemplary explanation of the situation where the first information directly indicates that the PDU sets are not successfully transmitted, in conjunction with FIG. 8.

As shown in FIG. 8, the sender sends three PDU sets to the receiver, namely PDU set 810, PDU set 820, and PDU set 830. Each PDU set includes three PDUs.

In FIG. 8, the sender fails to transmit PDU set 820 over the air interface due to sudden network congestion or other reasons. The sender has already assigned a PDCP serial number for PDU set 820 and may indicate how many untransmitted PDU sets are involved in the discontinuous PDCP serial numbers through the first notification shown in FIG. 8. If one PDU set is not transmitted, the sender may notify the receiver that “one PDU set is not transmitted.” If X PDU sets are not transmitted, the sender may also notify via the first notification as shown in FIG. 8, stating “X PDU sets are not transmitted.” It should be noted that “X PDU sets are not transmitted” may refer to that all PDUs in the X PDU sets are not transmitted or refer to some PDUs in the X PDU sets are not transmitted.

Referring to the situation corresponding to a second notification in FIG. 8, PDU set 820 was dropped before the sender assigns the PDCP serial numbers. As shown in FIG. 8, the PDCP serial numbers received by the receiver are continuous. In this case, the sender may notify the receiver that “X PDU sets are not transmitted” based on the dropped X PDU sets, or it may notify the receiver regarding PDU set 820 that “one PDU set is dropped.” After receiving this notification, even if the PDCP serial numbers received are continuous, the receiver will count this PDU set in the PSER. In this case, if the sender does not notify the receiver, the receiver will not count this PDU set in the PSER. For uplink, whether to send a notification in this case is configured by the base station through RRC messages. For downlink, whether to send a notification in this case is determined by the base station itself.

In the example shown in FIG. 8, the notification is transmitted before PDU set 830. That is to say, the sender adopts a manner of notifying the receiver as real-time as possible. In practice, the sender may also transmit this notification in a different order. For example, when the sender finds that all TBs for transmitting PDU set 820 have failed to be transmitted, PDU set 830 has already begun transmission, and this notification may be transmitted during the transmission of PDU set 830. In another Case, when the sender has already found that the network cannot transmit PDU set 820 due to congestion or poor wireless link quality during the transmission of PDU set 810, it may generate and send the notification during the transmission of PDU set 810. In actual transmission processes, this notification may be transmitted via the PDCP control PDU or MAC CE.

The method embodiments of the present disclosure are described in detail above with reference to FIG. 1 to FIG. 8. Apparatus embodiments of the present disclosure are described in detail below with reference to FIG. 9 to FIG. 11. It should be understood that the descriptions of the apparatus embodiments correspond to the descriptions of the method embodiments, and therefore, reference may be made to the foregoing method embodiments for parts that are not described in detail.

FIG. 9 is a schematic block diagram of an apparatus for wireless communication according to an embodiment of the present disclosure. The apparatus may be any first communication device described above. The apparatus 900 shown in FIG. 9 includes a receiving unit 910.

The receiving unit 910 is configured to receive first information, where the first information is used to determine a PDU set error rate corresponding to one or more PDU sets that a second communication device needs to transmit to the first communication device. The first information includes one or more of: second information corresponding to the one or more PDU sets, where the second information is used for the first communication device to determine whether a received PDU set is successfully transmitted; a number of the one or more PDU sets; and a number of unsuccessfully transmitted PDU sets in the one or more PDU sets.

Alternatively, the one or more PDU sets include a first PDU set, the second information includes indication information corresponding to the first PDU set, and the indication information includes one or more of: a number of PDUs included in the first PDU set; a number of bits or bytes included in the first PDU set; a start PDCP serial number of the PDUs included in the first PDU set; and an end PDCP serial number of the PDUs included in the first PDU set.

Alternatively, the second information includes first serial numbers assigned by the second communication device to PDU sets in the one or more PDU sets and PDCP serial numbers assigned by the second communication device to PDUs in the one or more PDU sets, and the apparatus 900 further includes a first determining unit configured to determine the number of unsuccessfully transmitted PDU sets in the one or more PDU sets according to the received first serial numbers of the PDU sets and/or the received PDCP serial numbers of the PDUs.

Alternatively, the first determining unit is further configured to: determine the number of unsuccessfully transmitted PDU sets in the one or more PDU sets according to the first serial numbers received by the first communication device if the first serial numbers received by the first communication device are discontinuous; and determine the number of unsuccessfully transmitted PDU sets in the one or more PDU sets according to the second information if the first serial numbers received by the first communication device are continuous.

Alternatively, the first determining unit is further configured to: determine the unsuccessfully transmitted PDU sets in the one or more PDU sets according to indication information if the first serial numbers received by the first communication device are continuous and the PDCP serial numbers of the PDUs received by the first communication device are discontinuous; and determine the unsuccessfully transmitted PDU sets according to a number of PDUs, a number of bits, or a number of bytes included in the PDU sets received by the first communication device if the first serial numbers received by the first communication device are continuous and the PDCP serial numbers of the PDUs received by the first communication device are continuous.

Alternatively, the PDCP serial numbers of the PDUs in the one or more PDU sets are assigned in terms of PDU sets.

Alternatively, the second information is transmitted through one or more of a PDCP control PDU, a PDCP header, and a MAC CE.

Alternatively, the second information includes indication information corresponding to a first PDU set, the indication information is transmitted through the PDCP header, and the indication information is carried in the PDCP header of one or more PDUs in the first PDU set.

Alternatively, the first information includes the number of unsuccessfully transmitted PDU sets in the one or more PDU sets, and the apparatus 900 includes a second determining unit configured to determine the PDU set error rate by determining the number of the one or more PDU sets based on the first information and a number of received PDU sets.

Alternatively, the first information is further used to indicate a transmission status of the unsuccessfully transmitted PDU sets, and the transmission status includes one of: PDUs in the unsuccessfully transmitted PDU sets being not assigned PDCP serial numbers; the PDUs in the unsuccessfully transmitted PDU sets having the PDCP serial numbers but being not transmitted; and the PDUs in the unsuccessfully transmitted PDU sets having the PDCP serial numbers and being transmitted.

Alternatively, the first communication device is a terminal device, and the receiving unit 910 is further configured to receive configuration information sent by the network device, where the configuration information is used for the first communication device to determine, based on the transmission status and configuration information of a network device, whether to use the unsuccessfully transmitted PDU sets to calculate the PDU set error rate.

Alternatively, the first information is carried in one or more of RRC signaling, a PDCP control PDU, a MAC CE, and a PDCP header of a transmitted PDU in the one or more PDU sets.

Alternatively, the first information includes the number of one or more PDU sets, and the apparatus 900 further includes a third determining unit configured to determine the PDU set error rate corresponding to the one or more PDU sets according to the first information and a number of received PDU sets.

Alternatively, the third determining unit is further configured to determine the number of unsuccessfully transmitted PDU sets based on the indication information corresponding to the received PDU sets.

Alternatively, a way for sending the first information is one of: sending at a periodicity of a first time interval; and sending based on an event trigger.

Alternatively, the first information is sent based on the event trigger, and the receiving unit 910 is further configured to receive the first information sent by the second communication device in a first time window.

Alternatively, parameters of the first time window are determined according to a configuration of a network device.

Alternatively, the first communication device is a base station and a way for a UPF corresponding to the base station to determine the PDU set error rate is one of: determining according to the PDU set error rate sent by the base station; and determining according to transmission information sent by the base station.

FIG. 10 is another schematic block diagram of an apparatus for wireless communication according to an embodiment of the present disclosure. The apparatus may be any second communication device described above. The apparatus 1000 shown in FIG. 10 includes a sending unit 1010.

The sending unit 1010 is configured to send first information to a first communication device, where the first information is used to determine a PDU set error rate corresponding to one or more PDU sets that a second communication device needs to transmit to a first communication device. The first information includes one or more of: second information corresponding to the one or more PDU sets, where the second information is used for the first communication device to determine whether a received PDU set is successfully transmitted; a number of the one or more PDU sets; and a number of unsuccessfully transmitted PDU sets in the one or more PDU sets.

Alternatively, the one or more PDU sets include a first PDU set, the second information includes indication information corresponding to the first PDU set, and the indication information includes one or more of: a number of PDUs included in the first PDU set, a number of bits or bytes included in the first PDU set; a start PDCP serial number of the PDUs included in the first PDU set; and an end PDCP serial number of the PDUs included in the first PDU set.

Alternatively, the second information includes first serial numbers of PDU sets and PDCP serial numbers of PDUs, the first serial numbers and/or the PDCP serial numbers are used for the first communication device to determine the number of unsuccessfully transmitted PDU sets in the one or more PDU sets, and the apparatus 1000 further includes a first assigning unit configured to assign the first serial numbers to the PDU sets in the one or more PDU sets and the PDCP serial numbers to the PDUs in the one or more PDU sets.

Alternatively, the first assigning unit is further configured to assign the PDCP serial numbers to the PDUs in the one or more PDU sets in terms of PDU sets.

Alternatively, the second information is transmitted through one or more of a PDCP control PDU and a PDCP header.

Alternatively, the second information includes indication information corresponding to a first PDU set, the indication information is transmitted through the PDCP header, and the indication information is carried in the PDCP header of one or more PDUs in the first PDU set.

Alternatively, the first information includes the number of unsuccessfully transmitted PDU sets in the one or more PDU sets, the first information is indicated via third information or fourth information, and the apparatus 1000 further includes: a first determining unit, configured to determine X PDU sets that are not successfully transmitted according to an actual transmission status and/or transmission feedback of a PDU set, where X is an integer greater than 0; and the sending unit 1010 is further configured to send X third information to the first communication device, where the third information is used to indicate that one PDU set is not successfully transmitted; or the sending unit 1010 is further configured to send the fourth information to the first communication device, where the fourth information is used to indicate that the X PDU sets are not successfully transmitted.

Alternatively, the first information is further used to indicate a transmission status of the unsuccessfully transmitted PDU sets, and the transmission status includes one of: PDUs in the unsuccessfully transmitted PDU sets being not assigned PDCP serial numbers; the PDUs in the unsuccessfully transmitted PDU sets having the PDCP serial numbers but being not transmitted; and the PDUs in the unsuccessfully transmitted PDU sets having the PDCP serial numbers and being transmitted.

Alternatively, the second communication device is a network device, and the sending unit 1010 is further configured to send configuration information to the first communication device, where the configuration information is used for the first communication device to determine, based on the transmission status of the unsuccessfully transmitted PDU sets, whether to use the unsuccessfully transmitted PDU sets to calculate the PDU set error rate.

Alternatively, the first determining unit is further configured to determine that a second PDU set is not successfully transmitted, and the sending unit 1010 is further configured to send fifth information to the first communication device, where the fifth information is used to indicate whether the second PDU set is used to calculate the PDU set error rate.

Alternatively, the first information includes the number of the one or more PDU sets, and the apparatus 1000 further includes: a second allocation unit, configured to assigning unit, configured to assign PDCP serial numbers to PDUs in all PDU sets that need to be transmitted; and the sending unit 1010 is further configured to send the first information to the first communication device, where the first information is used to indicate a number of PDU sets that are assigned the PDCP serial numbers.

Alternatively, a way for sending the first information is one of: sending by using sending at a periodicity of a first time interval; and sending based on an event trigger.

Alternatively, the first information is sent based on the event trigger, and the sending unit 1010 is further configured to send, by the second communication device, the first information or trigger the sending of the first information to the first communication device in a first time window.

Alternatively, parameters of the first time window are determined according to a configuration of a network device.

Alternatively, the first time interval is determined according to a configuration of the network device.

Alternatively, the first information is carried in one or more of RRC signaling, a PDCP control PDU, a MAC CE, and a PDCP header of a transmitted PDU.

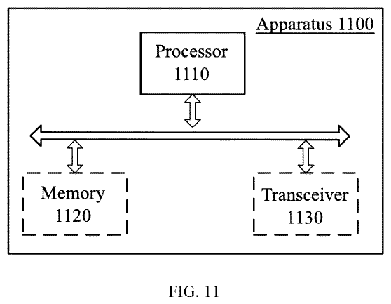

FIG. 11 is a schematic structural diagram of an apparatus for communication according to an embodiment of the present disclosure. The dashed line in FIG. 11 indicates that the unit or module is optional. The apparatus 1100 may be configured to implement the method described in the foregoing method embodiments. The apparatus 1100 may be a chip, a terminal device, or a network device.

The apparatus 1100 may include one or more processors 1110, and the processor 1110 may support the apparatus 1100 to implement the method described in the foregoing method embodiments. The processor 1110 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or other programmable logic devices, a discrete gate or transistor logic device, a discrete hardware component, or the like. The general-purpose processor may be a microprocessor, or the processor may be any conventional processor or the like.

The apparatus 1100 may further include one or more memories 1120 storing a program, and the program may be executed by the processor 1110 to cause the processor 1110 to perform the method described in the foregoing method embodiments. The memory 1120 may be independent of the processor 1110 or may be integrated into the processor 1110.

The apparatus 1100 may further include a transceiver 1130, and the processor 1110 may communicate with another device or chip via the transceiver 1130. For example, the processor 1110 may perform data transceiving with another device or chip via the transceiver 1130.

Embodiments of the present disclosure further provide a computer-readable storage medium, configured to store a program. The computer-readable storage medium may be applied to the terminal or network device provided in the embodiments of the present disclosure, and the program causes the computer to perform the method performed by the terminal or network device in the embodiments of the present disclosure.

It should be understood that the computer-readable storage medium may be any usable medium readable by a computer, or a data storage device, such as a server or a data center including one or more integrated usable media. The usable medium may be a magnetic medium (e.g., a floppy disk, a hard disk, or a magnetic tape), an optical medium (e.g., a digital video disk (DVD)), a semiconductor medium (e.g., a solid state disk (SSD)), or the like.

Embodiments of the present disclosure further provide a computer program product. The computer program product includes a program. The computer program product may be applied to the terminal or network device provided in the embodiments of the present disclosure, and the program causes the computer to perform the method performed by the terminal or network device in the embodiments of the present disclosure.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, the procedures or functions according to the embodiments of the present disclosure are all or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium, for example, the computer instructions may be transmitted from a website, a computer, a server, or a data center to another website, computer, server, or data center in a wired (e.g., a coaxial cable, an optical fiber, a digital subscriber line (DSL)) or a wireless (e.g., infrared, wireless, microwave, etc.) manner.

Embodiments of the present disclosure further provide a computer program. The computer program may be applied to the terminal or network device provided in the embodiments of the present disclosure, and the computer program causes the computer to perform the method performed by the terminal or network device in the embodiments of the present disclosure.

The terms “system” and “network” in the present disclosure may be used interchangeably. In addition, the terms used in the present disclosure are merely used to explain specific embodiments of the present disclosure and are not intended to limit the present disclosure. In the description, claims, and accompanying drawings of the present disclosure, the terms “first”, “second”, “third”, “fourth”, and the like are used to distinguish different objects rather than describe a specific order. In addition, the terms “including” and “having” and any variations thereof are intended to cover non-exclusive inclusion.

The term “indication” mentioned in the embodiments of the present disclosure may be a direct indication, or may be an indirect indication, or may indicate that there is an association relationship. For example, A indicates B, which may indicate that A directly indicates B, e.g., B is obtained through A, or may indicate that A indirectly indicates B, e.g., A indicates C and B is obtained through C, or may indicate that A and B have an association relationship.

The term “corresponding” may indicate that there is a direct correspondence or indirect correspondence between the two, or may indicate that there is an association relationship between the two, or may be relationships such as indicating and being indicated, configuring and being configured, etc.

In the embodiments of the present disclosure, the terms “predefined” or “preconfigured” may be implemented by pre-storing a corresponding code, a table, or another manner that can be used to indicate related information in a device (e.g., a terminal device and a network device), and a specific implementation is not limited in the present disclosure. For example, the predefined may indicate being defined in a protocol.

In the embodiments of the present disclosure, the term “protocol” in the embodiments of the present disclosure may refer to a standard protocol in the field of communications, such as an LTE protocol, an NR protocol, and related protocols applied to a future communication system, which is not limited in the present disclosure.

In the embodiments of the present disclosure, determining B based on A does not mean that B is determined only based on A, or B may also be determined based on A and/or other information.

In the embodiments of the present disclosure, the term “and/or” in this specification is merely an association relationship for describing associated objects, indicating that there are three relationships, e.g., A and/or B may indicate that A exists alone, A and B exist at the same time, and B exists alone. In addition, the character “/” in this specification generally indicates an “or” relationship between the associated objects.

In various embodiments of the present disclosure, a size of a serial number of each process does not mean an execution sequence, and the execution sequence of each process should be determined by its function and internal logic but should not constitute any limitation on an implementation process of the embodiments of the present disclosure.

In the several embodiments provided in the present disclosure, it should be understood that the disclosed system, apparatus, and method may be implemented in other manners. For example, the apparatus embodiments described above are merely illustrative, and the division of the units is merely a logical function division. In actual implementation, there may be alternative division manners, such as combining a plurality of units or components or integrating them into another system, or ignoring or not executing some features. In addition, the shown or discussed mutual coupling or direct coupling or communication connection may be indirect coupling or communication connection through some interfaces, devices, or units, which may be electrical, mechanical, or in other forms.

The units described as separate parts may or may not be physically separate, and parts shown as units may or may not be physical units, i.e., may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

The foregoing descriptions are merely specific implementations of the present disclosure, but the protection scope of the present disclosure is not limited thereto, and any changes or substitutions may be easily conceived of by a person skilled in the art within the technical scope disclosed in the present disclosure. Therefore, the protection scope of the present disclosure shall be subject to the protection scope of the claims.

What is claimed is:

1. A method for wireless communication, comprising:
receiving, by a first communication device, first information, wherein the first information is used to determine a protocol data unit (PDU) set error rate corresponding to one or more PDU sets that a second communication device needs to transmit to the first communication device;
wherein the first information includes at least one of:
second information corresponding to the one or more PDU sets, wherein the second information is used for the first communication device to determine whether a received PDU set is successfully transmitted;
a number of the one or more PDU sets; or
a number of unsuccessfully transmitted PDU sets in the one or more PDU sets.

2. The method according to claim 1, wherein the one or more PDU sets include a first PDU set, the second information includes indication information corresponding to the first PDU set, and the indication information includes at least one of:
a number of PDUs included in the first PDU set;
a number of bits or bytes included in the first PDU set;
a start packet data convergence protocol (PDCP) serial number of the PDUs included in the first PDU set; or
an end PDCP serial number of the PDUs included in the first PDU set.

3. The method according to claim 1, wherein the second information includes first serial numbers assigned by the second communication device to PDU sets in the one or more PDU sets and PDCP serial numbers assigned by the second communication device to PDUs in the one or more PDU sets, and the method further comprises:
determining, by the first communication device, the number of unsuccessfully transmitted PDU sets in the one or more PDU sets according to at least one of first serial numbers of PDU sets received by the first communication device or PDCP serial numbers of PDUs received by the first communication device.

4. The method according to claim 3, further comprising:
determining, by the first communication device, the number of unsuccessfully transmitted PDU sets in the one or more PDU sets according to the first serial numbers received by the first communication device if the first serial numbers received by the first communication device are discontinuous; and
determining, by the first communication device, the number of unsuccessfully transmitted PDU sets in the one or more PDU sets according to the second information if the first serial numbers received by the first communication device are continuous.

5. The method according to claim 4, wherein determining, by the first communication device, the number of unsuccessfully transmitted PDU sets in the one or more PDU sets according to the second information if the first serial numbers received by the first communication device are continuous includes:
determining, by the first communication device, the unsuccessfully transmitted PDU sets in the one or more PDU sets according to indication information of the PDU sets if the first serial numbers received by the first communication device are continuous and the PDCP serial numbers of the PDUs received by the first communication device are discontinuous; and
determining, by the first communication device, the unsuccessfully transmitted PDU sets according to a number of PDUs, a number of bits, or a number of bytes included in the PDU sets received by the first communication device if the first serial numbers received by the first communication device are continuous and the PDCP serial numbers of the PDUs received by the first communication device are continuous.

6. The method according to claim 3, wherein the PDCP serial numbers of the PDUs in the one or more PDU sets are assigned in terms of PDU sets.

7. The method according to claim 1, wherein the second information is transmitted through one or more of a PDCP control PDU, a PDCP header, and a media access control control element (MAC CE).

8. The method according to claim 7, wherein the second information includes indication information corresponding to a first PDU set, the indication information is transmitted through the PDCP header, and the indication information is carried in the PDCP header of one or more PDUs in the first PDU set.

9. The method according to claim 1, wherein the first information includes the number of unsuccessfully transmitted PDU sets in the one or more PDU sets, and the method further comprises:
determining, by the first communication device, the PDU set error rate by determining the number of the one or more PDU sets based on the first information and a number of received PDU sets.

10. The method according to claim 9, wherein the first information indicates a transmission status of the unsuccessfully transmitted PDU sets, and the transmission status includes one of:
PDUs in the unsuccessfully transmitted PDU sets being not assigned PDCP serial numbers;
PDUs in the unsuccessfully transmitted PDU sets having the PDCP serial numbers but being not transmitted; or
PDUs in the unsuccessfully transmitted PDU sets having the PDCP serial numbers and being transmitted.

11. The method according to claim 10, wherein the first communication device is a terminal device, and the method further comprises:
receiving, by the first communication device, configuration information sent by a network device, wherein the configuration information is used for the first communication device to determine, based on the transmission status, whether to use the unsuccessfully transmitted PDU sets to calculate the PDU set error rate.

12. The method according to claim 9, wherein the first information is carried in at least one of radio resource control (RRC) signaling, a PDCP control PDU, a MAC CE, or a PDCP header of a transmitted PDU in the one or more PDU sets.

13. The method according to claim 1, wherein the first information includes the number of the one or more PDU sets, and the method further includes:
determining, by the first communication device, the PDU set error rate corresponding to the one or more PDU sets based on the first information and a number of received PDU sets.

14. The method according to claim 13, further comprising:
determining, by the first communication device, the number of unsuccessfully transmitted PDU sets based on indication information corresponding to the received PDU sets.

15. The method according to claim 1, wherein a way for sending the first information is one of:
sending at a periodicity of a first time interval; or
sending based on an event trigger.

16. The method according to claim 15, wherein the first information is sent based on the event trigger, and the method further comprises:
receiving, by the first communication device, the first information sent by the second communication device in a first time window.

17. The method according to claim 16, wherein parameters of the first time window are determined according to a configuration of a network device.

18. The method according to claim 1, wherein the first communication device is a base station, and a way for a user plane function (UPF) corresponding to the base station to determine the PDU set error rate is one of:
determining according to the PDU set error rate sent by the base station; or
determining according to transmission information sent by the base station.

19. A method for wireless communication, comprising:
sending, by a second communication device, first information to a first communication device, wherein the first information is used to determine a protocol data unit (PDU) set error rate corresponding to one or more PDU sets that the second communication device needs to transmit to the first communication device;
wherein the first information includes at least one of:
second information corresponding to the one or more PDU sets, wherein the second information is used for the first communication device to determine whether a received PDU set is successfully transmitted;
a number of the one or more PDU sets; or
a number of unsuccessfully transmitted PDU sets in the one or more PDU sets.

20. A first communication device, comprising:
at least one processor; and
one or more non-transitory computer-readable storage media coupled to the at least one processor and storing programming instructions for execution by the at least one processor, wherein the programming instructions, when executed, cause the first communication device to perform operations comprising:
receiving first information, wherein the first information is used to determine a protocol data unit (PDU) set error rate corresponding to one or more PDU sets that a second communication device needs to transmit to the first communication device;
wherein the first information includes at least one of:
second information corresponding to the one or more PDU sets, wherein the second information is used for the first communication device to determine whether a received PDU set is successfully transmitted;
a number of the one or more PDU sets; or
a number of unsuccessfully transmitted PDU sets in the one or more PDU sets.
